(19) United States
(12) Patent Application Publication
(10) Pub. No.: US 2025/0380622 A1
(43) Pub. Date: Dec. 18, 2025

(54) SYSTEM AND METHOD FOR CONTROLLING THE OPERATION OF AN AGRICULTURAL IMPLEMENT

(71) Applicant: CNH Industrial America LLC, New Holland, PA (US)

(72) Inventor: Michael Jacob Digman, Denver, PA (US)

(21) Appl. No.: 18/742,383

(22) Filed: Jun. 13, 2024

(51) Int. Cl. A01B 69/00; A01B 76/00; B60T 8/17

(52) U.S. Cl. CPC A01B 69/004; A01B 76/00; B60T 8/1701

(57) ABSTRACT

A system for controlling the operation of an agricultural implement includes a vehicle wheel, a sensor configured to generate data of wheel slip of the vehicle wheel, an implement wheel, and a regenerative braking assembly. The braking assembly includes an energy storage device and an electric motor configured to receive electrical power from the storage device for rotating the implement wheel, and supply power to the storage device. Moreover, the braking assembly includes a regenerative brake configured to rotationally drive the motor such that power is supplied by the motor to the storage device when the brake engages the motor. Additionally, the system includes a computing system configured to determine the wheel slip of the vehicle wheel based on the data generated by the sensor. Furthermore, the computing system is configured to control the operation of the brake to rotationally drive the motor based on the determined wheel slip.

### FIELD OF THE INVENTION

The present disclosure generally relates to agricultural implements and, more particularly, to systems and methods for controlling the operation of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. In certain configurations, tillage implements include one or more ground-engaging tools, such as shanks and/or spaced apart disks, supported on its frame. Each ground-engaging tool of the tillage implement loosens and/or otherwise agitates the soil to prepare the field for subsequent planting operations.

The tillage implement may drift from an intended or selected position while being towed, such as when it is towed across a hill during operations or when it encounters an otherwise uneven surface in the road or field over which it is moving. During tilling operations, the tillage implement not being in the selected position may negatively impact tilling operations by, for example, leading to under tilling and/or over tilling of portions of the field and/or may result in the tillage implement encountering adverse field conditions, such as wet or muddy soil. Additionally, correction of the implement position may require significant energy consumption. In this respect, systems and methods have been developed to reduce these issues. While such systems and methods work well, further improvements are needed.

Accordingly, an improved system and method for controlling the operation of an agricultural implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural machine. The agricultural machine includes a work vehicle including a vehicle wheel configured to move the work vehicle in a direction of travel. Additionally, the agricultural machine includes a wheel slip sensor configured to generate data indicative of wheel slip of the vehicle wheel relative to the ground. Furthermore, the agricultural machine includes an agricultural implement configured to be towed by the work vehicle. The agricultural implement includes an implement wheel configured to move the agricultural implement in the direction of travel. Moreover, the agricultural implement includes a regenerative braking assembly. The regenerative brake assembly includes an energy storage device. Additionally, the regenerative brake assembly includes an electric motor coupled to the energy storage device. Furthermore, the regenerative brake assembly includes a regenerative brake configured to rotationally drive the electric motor. Moreover, the agricultural machine includes a computing system communicatively coupled to the wheel slip sensor and the regenerative brake. The computing system is configured to determine the wheel slip of the vehicle wheel based on the data generated by the wheel slip sensor. Additionally, the computing system is configured to control an operation of the regenerative brake to rotationally drive the electric motor based on the determined wheel slip.

In another aspect, the present subject matter is directed to a system for controlling the operation of an agricultural implement. The system includes a vehicle wheel of a work vehicle configured to move the work vehicle in a direction of travel. Additionally, the system includes a wheel slip sensor configured to generate data indicative of wheel slip of the vehicle relative to the ground. Furthermore, the system includes an implement wheel of an agricultural implement configured to be towed by the work vehicle. The implement wheel is configured to move the agricultural implement in the direction of travel. Moreover, the system includes a regenerative brake assembly of the agricultural implement. The regenerative brake assembly includes an energy storage device. Additionally, the regenerative brake assembly includes an electric motor electrically coupled to the energy storage device. The electric motor is configured to receive electrical power from the energy storage device for rotating the implement wheel, and supply power to the energy storage device. Furthermore, the system includes a computing system communicatively coupled to the wheel slip sensor and the regenerative brake. The computing system is configured to determine the wheel slip of the vehicle wheel based on the data generated by the wheel slip sensor. Moreover, the computing system is configured to control an operation of the regenerative brake to rotationally drive the electric motor based on the determined wheel slip.

In a further aspect, the present subject matter is directed to a method for controlling the operation of an agricultural implement. The method includes receiving, with a computing system, wheel slip sensor data indicative of a wheel slip of a vehicle wheel of a work vehicle. Additionally, the method includes determining, with the computing system, the wheel slip of the vehicle wheel based on the received wheel slip sensor data. Furthermore, the method includes controlling, with the computing system, an operation of a regenerative brake of a regenerative brake assembly of an agricultural implement to engage an electric motor of the regenerative brake assembly based on the determined wheel slip.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural machine in accordance with aspects of the present subject matter;

FIG. 2A illustrates a side view of the agricultural machine shown in FIG. 1 traversing an incline;

FIG. 2B illustrates a side view of the agricultural machine shown in FIG. 1 traversing a decline;

FIG. 3 illustrates a schematic view of one embodiment of a system for controlling the operation of an agricultural implement in accordance with aspects of the present subject matter;

FIG. 4 illustrates a flow diagram of one embodiment of example control logic for controlling the operation of an agricultural implement in accordance with aspects of the present subject matter; and

FIG. 5 illustrates a flow diagram of one embodiment of a method for controlling the operation of an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for controlling the operation of an agricultural implement. As will be described below, an agricultural machine generally includes a work vehicle having one or more vehicle wheels. The agricultural machine also includes an agricultural implement configured to be towed by the work vehicle. The agricultural implement includes one or more implement wheels and a regenerative brake assembly for generating electrical power to drive the agricultural implement. The regenerative brake assembly, in turn, includes an energy storage device, such as a chargeable battery, and one or more electric motors electrically coupled to the energy storage device. The electric motor(s) is configured to receive electrical power from the energy storage device for rotating the implement wheel(s), and supply power to the energy storage device. Additionally, the regenerative brake assembly includes one or more regenerative brakes configured to rotationally drive the electric motor(s) such that electric power is supplied by the electric motor(s) to the energy storage device when the regenerative brake(s) engages the electric motor(s). In this respect, the regenerative brake(s) charges the energy storage device during braking operations.

In several embodiments, a computing system of the disclosed system is configured to control the operation of the regenerative brake(s) to rotationally drive the electric motor(s). More specifically, the computing system is configured to determine the wheel slip of the vehicle wheel(s) based on data generated by a wheel slip sensor and control the operation of the regenerative brake(s) to rotationally drive the electric motor(s) based on the determined wheel slip. In some embodiments, the computing system may be configured to determine when the work vehicle is traversing an incline or hill based on data generated by a terrain slope sensor, such as an inclinometer, and determine the wheel slip of the vehicle wheel(s) based on the data generated by the wheel slip sensor when it is determined that the work vehicle is traversing the incline. Thereafter, in some embodiments, the computing system may be configured to determine when the work vehicle is traversing a decline based on the data generated by the terrain slope sensor and control the operation of the regenerative brake(s) based on the wheel slip determined when the work vehicle was traversing the incline.

Using wheel slip to control the operation of regenerative brakes to supply electric power to an energy storage device improves the operation of the agricultural machine. More specifically, a work vehicle used for towing an implement may experience wheel slip when, for example, the work vehicle is traversing a field with muddy soil conditions and/or a hill. The muddy conditions or hill may cause one or more wheels of the work vehicle to experience rotational motion with limited or no corresponding translational motion and, thus, causing the wheel(s) to slip. An engine of the work vehicle experiencing wheel slip, especially when the work vehicle is towing an implement, may be required to produce significant power to overcome the wheel slip and/or steer the implement to avoid field conditions causing the wheel slip and, as a result, may use significant power. As described above, a wheel slip sensor is configured to generate data indicative of the wheel slip of one or more wheels of the work vehicle. A computing system then determines the wheel slip based on the data generated by the sensor and controls the operation of a regenerative brake to rotationally drive one or more electric motors of a regenerative brake assembly of the implement based on the wheel slip. Rotationally driving the electric motor(s) based on wheel slip allows sufficient electric power to be supplied by the electric motor(s) to an energy storage device (e.g., battery) of the regenerative brake assembly for later use. This allows an increased quantity of power to be generated for towing the implement through or steering the implement around field conditions causing wheel slip scenarios.

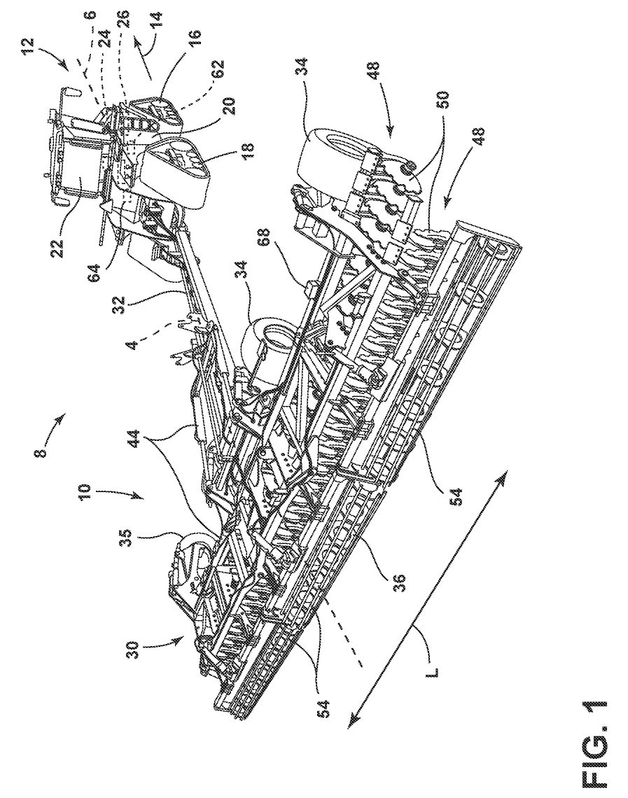

Referring now to the drawings, FIG. 1 illustrates a perspective view of the agricultural machine 8, with an agricultural implement 10 of the agricultural machine 8 configured as a tillage implement, coupled to a work vehicle 12 of the agricultural machine 8.

In general, the implement 10 may be configured to be towed across a field in a direction of travel (e.g., as indicated by arrow 14) by the work vehicle 12. As shown, the implement 10 is configured as a speed tillage implement and the work vehicle 12 is configured as an agricultural tractor. However, in other embodiments, the implement 10 may be configured as any other suitable type of tillage implement or other agricultural implement. Similarly, the work vehicle 12 may be configured as any other suitable type of vehicle.

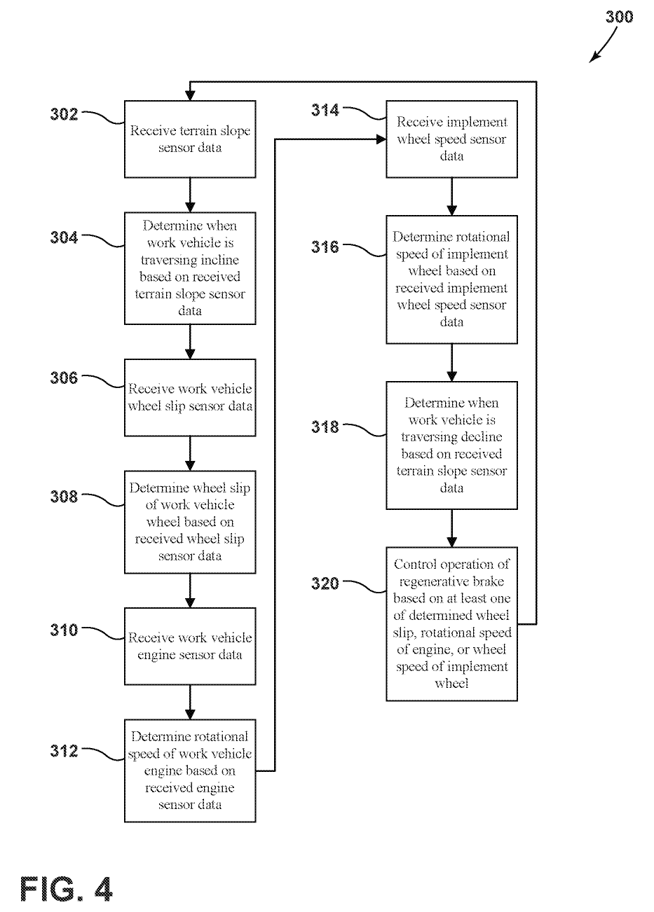

As shown in FIG. 1, the work vehicle 12 may include one or more vehicle wheels, such as a pair of front track assemblies 16, a pair or rear track assemblies 18, and a frame or chassis 20 coupled to and supported by the track assemblies 16, 18. An operator’s cab 22 may be supported by a portion of the chassis 20 and may house various input devices (e.g., a user interface 220 shown in FIG. 4) for permitting an operator to control the operation of one or more components of the work vehicle 12 and/or one or more components of the implement 10. Additionally, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIG. 1, the implement 10 may generally include an implement frame 30 configured to be towed by the work vehicle 12 via a pull hitch or tow bar 32 in the travel direction 14. The implement frame 30 may include aft extending implement frame members 36 coupled to the tow bar 32. Furthermore, a plurality of implement wheels, such as a first implement wheel 34 and a second implement wheel 35, may be coupled to the implement frame 30 to facilitate towing the implement 10 in the direction of travel 14. The first implement wheel 34 and the second implement wheel 35 may be spaced apart from one another on the implement 10 in a lateral direction L perpendicular to the direction of travel 14.

In general, the implement frame 30 may support a plurality of ground-engaging tools. The various ground-engaging tools may be configured to perform an agricultural operation, such as a tillage operation or any other suitable ground-engaging operation, across the field along which the implement 10 is being towed. For example, in one embodiment, the implement frame 30 may support various gangs or sets 48 of disk blades 50. Specifically, the disk blades 50 are spaced apart from each other along the length of the disk gang 48 and configured to rotate relative to the soil within the field as the agricultural implement 10 travels across the field in the travel direction 14. Furthermore, each disk blade 50 may include both a concave side (not shown) and a convex side (not shown). In addition, the various gangs 48 of disk blades 50 may be oriented at an angle relative to the travel direction 14 to promote more effective tilling of the soil.

Moreover, in one embodiment, the implement frame 30 may be configured to support a plurality rolling (or crumbler) basket assemblies 54. However, in other embodiments, any other suitable ground-engaging tools may be coupled to and supported by the implement frame 30, such as a plurality of shanks, tines, spikes, and/or the like.

Additionally, in several embodiments, the implement 10 may include one or more actuators 44 (one is shown), such as a hydraulic actuator(s). In general, each actuator(s) 44 is configured to adjust the position of the implement frame 30 and/or subframes of the implement 10 to adjust a position of the ground-engaging tools relative to the field. For example, in some embodiments the actuator(s) 44 may be configured to adjust the soil penetration depth of the ground-engaging tools. As such, the actuator(s) 44 may raise the implement frame 30 to decrease the soil penetration depth of the ground-engaging tools and/or lower the implement frame 30 to increase the soil penetration depth of the ground-engaging tools. However, it should be appreciated that the actuator(s) 44 may be configured to adjust the position of the ground-engaging tools in any other suitable manner. For example, the actuator(s) 44 may be configured to adjust a lateral and/or longitudinal position of the ground-engaging tools.

The configuration of the implement 10 and the work vehicle 10 of the agricultural machine 8 described above and shown in FIG. 1 is provided only to place the present subject matter in an exemplary field of use. Thus, the present subject matter may be readily adaptable to any manner of implement and/or vehicle configuration.

As particularly shown in FIG. 1, one or more wheel slip sensors 62 may be positioned on the agricultural machine 8. In general, the wheel slip sensor(s) 62 is configured to generate data indicative of the occurrence of wheel slip of one or more of the vehicle wheels/track assemblies 16, 18 of the work vehicle 12 of the agricultural machine 8 relative to the ground. Such wheel slip results when the wheel(s)/track assembly(ies) 16, 18 of the work vehicle 12 experience rotational motion with limited or no corresponding translational motion. The data generated by the wheel slip sensor(s) 62 may, in turn, subsequently be used to determine a selected position for the implement 10 to be steered to.

In general, the wheel slip sensor(s) 62 may correspond to any suitable sensing device(s) configured to generate data indicative of the occurrence of wheel slip of the vehicle wheel(s)/track assembly(ies) 16, 18 of the work vehicle 12 relative to the ground. For example, in one embodiment, the wheel slip sensor(s) 62 may correspond to a proximity sensor(s). However, in alternative embodiments, the wheel slip sensor(s) 62 may correspond to any other suitable sensing device(s) such as an imaging device(s) and/or the like.

Furthermore, any number of wheel slip sensor(s) 62 may be positioned on the agricultural machine 8 and configured to generate data indicative of the occurrence of wheel slip of the wheel(s)/track assembly(ies) 16, 18 of the work vehicle 12. For example, in the embodiment shown in FIG. 1, one wheel slip sensor 62 is positioned on the frame 20 of the work vehicle 12 above one of the rear track assemblies 18 and the other wheel slip sensor 62 is positioned on the frame of the work vehicle 12 above one of the forward track assemblies 16. However, it should be appreciated that the agricultural machine 8 may include any other suitable number of wheel slip sensors 62, such as a single wheel slip sensor 62, positioned at any suitable location on the agricultural machine 8 for generating data indicative of the occurrence of wheel slip of the wheel(s)/track assembly(ies) 16, 18.

Additionally, one or more terrain slope sensors 68 may be positioned on the agricultural machine 8. In general, the terrain slope sensor(s) 68 is configured to generate data indicative of a slope of the terrain over which the agricultural implement 10 traverses. For example, the agricultural machine 8, which includes the implement 10, may ascend a hill/traverse an incline in the direction of travel 14. As such, the terrain slope sensor(s) 68 are configured to generate data indicative of the slope of the incline. Additionally, the agricultural machine 8 may descend a hill/traverse a decline in the direction of travel 14. As such, the terrain slope sensor(s) 68 are configured to generate data indicative of the slope of the decline. The data generated by the terrain slope sensor(s) 68 may, in turn, subsequently be used to determine a selected position for the implement 10 to be steered to.

In general, the terrain slope sensor(s) 68 may correspond to any suitable sensing device(s) configured to generate data indicative of the slope of the terrain over which the implement 10 traverses. For example, in one embodiment, the terrain slope sensor(s) 68 may correspond to an inclinometer(s). However, in alternative embodiments, the terrain slope sensor(s) 68 may correspond to any other suitable sensing device(s), such as a gyroscope(s) and/or the like.

Furthermore, any number of terrain slope sensor(s) 68 may be positioned on the agricultural machine 8 and configured to generate data indicative of the slope of the terrain over which the implement 10 traverses. For example, in the embodiment shown in FIG. 1, the terrain slope sensor 68 is positioned on the implement frame 30 of the implement 10. However, it should be appreciated that the terrain slope sensor(s) 68 may be positioned at any other suitable location on the agricultural machine 8 for generating data indicative of the slope of the terrain over which the implement 10 is traversing.

As shown in FIG. 1, the implement 10 may generally include an implement frame 30 configured to be towed by the work vehicle 12 via a pull hitch or tow bar 32 in the travel direction 14. The implement frame 30 may include aft extending implement frame members 36 coupled to the tow bar 32. Furthermore, a plurality of implement wheels, such as a first implement wheel 34 and a second implement wheel 35, may be coupled to the implement frame 30 to facilitate towing the implement 10 in the direction of travel 14. The first implement wheel 34 and the second implement wheel 35 may be spaced apart from one another on the implement 10 in a lateral direction L perpendicular to the direction of travel 14.

In general, the implement frame 30 may support a plurality of ground-engaging tools. The various ground-engaging tools may be configured to perform an agricultural operation, such as a tillage operation or any other suitable ground-engaging operation, across the field along which the implement 10 is being towed. For example, in one embodiment, the implement frame 30 may support various gangs or sets 48 of disk blades 50. Specifically, the disk blades 50 are spaced apart from each other along the length of the disk gang 48 and configured to rotate relative to the soil within the field as the agricultural implement 10 travels across the field in the travel direction 14. Furthermore, each disk blade 50 may include both a concave side (not shown) and a convex side (not shown). In addition, the various gangs 48 of disk blades 50 may be oriented at an angle relative to the travel direction 14 to promote more effective tilling of the soil.

Moreover, in one embodiment, the implement frame 30 may be configured to support a plurality rolling (or crumbler) basket assemblies 54. However, in other embodiments, any other suitable ground-engaging tools may be coupled to and supported by the implement frame 30, such as a plurality of shanks, tines, spikes, and/or the like.

Additionally, in several embodiments, the implement 10 may include one or more actuators 44 (one is shown), such as a hydraulic actuator(s). In general, each actuator(s) 44 is configured to adjust the position of the implement frame 30 and/or subframes of the implement 10 to adjust a position of the ground-engaging tools relative to the field. For example, in some embodiments the actuator(s) 44 may be configured to adjust the soil penetration depth of the ground-engaging tools. As such, the actuator(s) 44 may raise the implement frame 30 to decrease the soil penetration depth of the ground-engaging tools and/or lower the implement frame 30 to increase the soil penetration depth of the ground-engaging tools. However, it should be appreciated that the actuator(s) 44 may be configured to adjust the position of the ground-engaging tools in any other suitable manner. For example, the actuator(s) 44 may be configured to adjust a lateral and/or longitudinal position of the ground-engaging tools.

The configuration of the implement 10 and the work vehicle 12 of the agricultural machine 8 described above and shown in FIG. 1 is provided only to place the present subject matter in an exemplary field of use. Thus, the present subject matter may be readily adaptable to any manner of implement and/or vehicle configuration.

As particularly shown in FIG. 1, one or more wheel slip sensors 62 may be positioned on the agricultural machine 8. In general, the wheel slip sensor(s) 62 is configured to generate data indicative of a wheel slip of one or more of the vehicle wheels/track assemblies 16, 18 of the work vehicle 12 of the agricultural machine 8 relative to the ground. Such wheel slip results when the wheel(s)/track assembly(ies) 16, 18 of the work vehicle 12 experience rotational motion with limited or no corresponding translational motion. As will be described below, the data generated by the wheel slip sensor(s) 62 is, in turn, subsequently used to determine the wheel slip of the vehicle wheel(s)/track assembly(ies) 16, 18.

In general, the wheel slip sensor(s) 62 may correspond to any suitable sensing device(s) configured to generate data indicative of the wheel slip of the vehicle wheel(s)/track assembly(ies) 16, 18 of the work vehicle 12 relative to the ground. For example, in one embodiment, the wheel slip sensor(s) 62 may correspond to a proximity sensor(s). However, in alternative embodiments, the wheel slip sensor(s) 62 may correspond to any other suitable sensing device(s) such as an imaging device(s) and/or the like.

Furthermore, any number of wheel slip sensor(s) 62 may be positioned on the agricultural machine 8 and configured to generate data indicative of the wheel slip of the wheel(s)/track assembly(ies) 16, 18 of the work vehicle 12. For example, in the embodiment shown in FIG. 1, one wheel slip sensor 62 is positioned on the frame 20 of the work vehicle 12 above one of the rear track assemblies 18 and the other wheel slip sensor 62 is positioned on the frame of the work vehicle 12 above one of the forward track assemblies 16. However, it should be appreciated that the agricultural machine 8 may include any other suitable number of wheel slip sensors 62, such as a single wheel slip sensor 62, positioned at any suitable location on the agricultural machine 8 for generating data indicative of the wheel slip of the wheel(s)/track assembly(ies) 16, 18.

Additionally, one or more engine sensors 64 may be positioned within the work vehicle 12. In general, the engine sensor(s) 64 is configured to generate data indicative of a rotational speed of the engine. As will be described below, the data generated by the engine sensor(s) 64 is, in turn, subsequently used to determine the rotational speed of the engine 24 of the work vehicle 12.

In general, the engine sensor(s) 64 may correspond to any suitable sensing device(s) configured to generate data indicative of the rotational speed of the engine 24 of the work vehicle 12. For example, in one embodiment, the engine sensor(s) 64 may correspond to a proximity sensor(s). However, in alternative embodiments, the engine sensor(s) 64 may correspond to any other suitable sensing device(s).

Furthermore, any number of engine sensor(s) 64 may be positioned within the work vehicle 12 and configured to generate data indicative of the rotational speed of the engine 24. For example, in the embodiment shown in FIG. 1, a single engine sensor 64 is positioned within the work vehicle 12. However, it should be appreciated that the work vehicle 12 may include any other suitable number of engine sensors 64, such as two or more engine sensors 64.

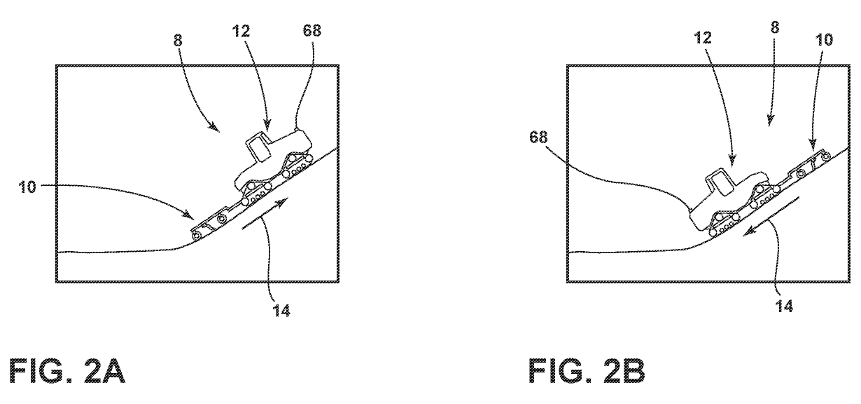

Additionally, one or more terrain slope sensors 68 may be positioned on the agricultural machine 8. In general, the terrain slope sensor(s) 68 is configured to generate data indicative of a slope of the terrain over which the work vehicle 12 traverses. For example, as shown in FIG. 2A, the agricultural machine 8, which includes the work vehicle 12, is ascending a hill/traversing an incline in the direction of travel 14. As such, the terrain slope sensor(s) 68 are configured to generate data indicative of the slope of the incline. Additionally, as shown in FIG. 2B, the agricultural machine 8 is descending the hill/traversing a decline in the direction of travel 14. As such, the terrain slope sensor(s) 68 are configured to generate data indicative of the slope of the decline. As will be described below, the data generated by the terrain slope sensor(s) 68 is, in turn, subsequently used to determine when the work vehicle 12 of the agricultural machine 8 is traversing an incline or decline.

In general, the terrain slope sensor(s) 68 may correspond to any suitable sensing device(s) configured to generate data indicative of the slope of the terrain over which the work vehicle 12 traverses. For example, in one embodiment, the terrain slope sensor(s) 68 may correspond to an inclinometer(s). However, in alternative embodiments, the terrain slope sensor(s) 68 may correspond to any other suitable sensing device(s), such as a gyroscope(s) and/or the like.

Furthermore, any number of terrain slope sensor(s) 68 may be positioned on the agricultural machine 8 and configured to generate data indicative of the slope of the terrain over which the work vehicle 12 traverses. For example, in the embodiment shown in FIG. 1, the terrain slope sensor 68 is positioned on the implement frame 30 of the implement 10. However, it should be appreciated that the terrain slope sensor(s) 68 may be positioned at any other suitable location on the agricultural machine 8 for generating data indicative of the slope of the terrain over which the work vehicle 12 is traversing.

Moreover, one or more wheel speed sensors 66 may be positioned on the implement 10. In general, the wheel speed sensor(s) 66 is configured to generate data indicative of a rotational speed one or more of the implement wheels 34, 35. As will be described below, the data generated by the wheel speed sensor(s) 66 is, in turn, subsequently used to determine the rotational speed of the implement wheel(s) 34, 35 of the implement 10.

In general, the wheel speed sensor(s) 66 may correspond to any suitable sensing device(s) configured to generate data indicative of the rotational speed of the implement wheel(s) 34, 35 of the implement 10. For example, in one embodiment, the wheel speed sensor(s) 66 may correspond to a proximity sensor(s). However, in alternative embodiments, the wheel speed sensor(s) 66 may correspond to any other suitable sensing device(s).

Furthermore, any number of wheel speed sensor(s) 66 may be positioned on the implement 10 and configured to generate data indicative of the rotational speed of the implement wheel(s) 34, 35. For example, in the embodiment shown in FIG. 1, the wheel speed sensor 66 is positioned on the implement frame 30 of the implement 10. However, it should be appreciated that the wheel speed sensor(s) 66 may be positioned at any other suitable location on the implement 10 for generating data indicative of the rotational speed of the implement wheel(s) 34, 35.

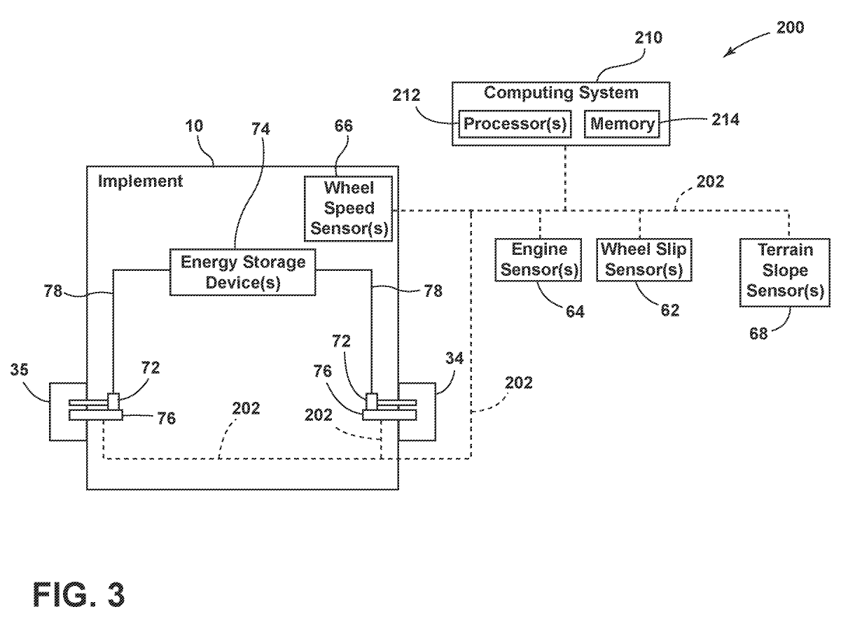

Referring now to FIG. 3, a schematic view of one embodiment of a system 200 for controlling the operation of an agricultural implement is illustrated in accordance with aspects of the present subject matter. In general, the system 200 will be described herein with reference to the agricultural implement 10 and the work vehicle 12 of the agricultural machine 8 described above with reference to FIGS. 1-2B. However, the disclosed system 200 may generally be utilized with agricultural implements having any other suitable implement configuration and/or with work vehicles having any other suitable vehicle configuration.

As shown in FIG. 3, a regenerative brake assembly 70 may be positioned on the implement 10 and include one or more electric motors 72 for rotating/driving the implement wheels 34, 35 to move the implement 10. As such, the implement 10 may assist the work vehicle 12 in moving the agricultural machine 8 in the direction of travel 14. Each electric motor 72 may be configured to drive/rotate one of the implement wheels 34, 35. In this respect, the implement wheels 34, 35 may be driven/rotated independently of each other.

Furthermore, the regenerative brake assembly 70 includes one or more energy storage devices 74, such as a chargeable battery(ies). The energy storage device(s) 74 may be electrically coupled to the electric motor(s) 72, for example, via electrical conduit/wiring 78, for providing electric power to and receiving electric power from the electric motor(s) 72. When providing electric power to the electric motor(s) 72, the energy storage device(s) 74 may configured to rotationally drive the electric motor(s) 72, such as a shaft(s) of the electric motor(s) 72, in a first direction such that the electric motor(s) 72 rotate/drive the implement wheels 34, 35 to move the implement 10.

Moreover, the regenerative brake assembly 70 includes one or more regenerative brakes 76. The regenerative brake(s) 76 is configured to rotationally drive the electric motor(s) 72 such that electric power is supplied by the electric motor(s) 72 to the energy storage device(s) 74 when the regenerative brake(s) 76 engages the electric motor(s) 72. As such, when the regenerative brake(s) 76 is activated, such as by one or more computing systems, the regenerative brake(s) 76 may rotationally drive the electric motor(s) 72 in a second direction different from the first direction such that mechanical power produced by rotation of the electric motor(s) 72 is converted to electric power and supplied to the energy storage device(s) 74 for later use. In this respect, increases in engagement of the regenerative brake(s) 76 with the electric motor(s) 72 results in increased rotational speed of the electric motor(s) 72 (e.g., shaft(s)) in the second direction and, thus, increases in the electric power supplied by the electric motor(s) 72 to the energy storage device(s) 74. Conversely, decreases in engagement of the regenerative brake(s) 76 with the electric motor(s) 72 results in decreased rotational speed of the electric motor(s) 72 (e.g., shaft(s)) in the second direction and, thus, decreases in the electric power supplied by the electric motor(s) 72 to the energy storage device(s) 74.

As shown in FIG. 4, the system 200 generally includes one or more components of the agricultural implement 10 and/or the work vehicle 12. For example, in the illustrated embodiment, the system 200 includes the wheel slip sensor(s) 62, the engine sensor(s) 64, the wheel speed sensor(s) 66, the terrain slope sensor(s) 68, and the regenerative brake(s) 76 of the agricultural machine 8.

Moreover, the system 200 includes a computing system 210 communicatively coupled to one or more components of the agricultural implement 10, the work vehicle 12, and/or the system 200 to allow the operation of such components to be electronically or automatically controlled by the computing system 210. For instance, the computing system 210 may be communicatively coupled to the wheel slip sensor(s) 62 via a communicative link 202. As such, the computing system 210 may be configured to receive data from the wheel speed sensor(s) 62. Furthermore, the computing system 210 may be communicatively coupled to the engine sensor(s) 64 via the communicative link 202. In this respect, the computing system 210 may be configured to receive data from the engine sensor(s) 64. Additionally, the computing system 210 may be communicatively coupled to the terrain slope sensor(s) 68 via the communicative link 202. In this respect, the computing system 210 may be configured to receive data from the terrain slop sensor(s) 68. Moreover, the computing system 210 may be communicatively coupled to the wheel speed sensor(s) 66 of the implement 10 via the communicative link 202. In this respect, the computing system may be configured to receive data from the wheel speed sensor(s) 66. Furthermore, the computing system 210 may be communicatively coupled to the regenerative brake(s) 76 of the regenerative brake assembly 70 of the implement 10 via the communicative link 202. In this respect, the computing system 210 may be configured to control the operation of the regenerative brake(s) 76. In addition, the computing system 210 may be communicatively coupled to any other suitable components of the implement 10, the vehicle 12, and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the implement 10 and/or the work vehicle 12, itself, or the computing system 210 may correspond to a separate processing device. For instance, in one embodiment, the computing system 210 may form all or part of a separate plug-in module that may be installed in association with the implement 10 and/or work vehicle 12 to allow for the disclosed systems to be implemented without requiring additional software to be uploaded onto existing control devices of the implement 10 and/or work vehicle 12.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

Referring now to FIG. 4, a flow diagram of one embodiment of control logic 300 that may be executed by the computing system 210 (or any other suitable computing system) for controlling the operation of an agricultural implement is illustrated in accordance with aspects of the present subject matter. Specifically, the control logic 300 shown in FIG. 4 is representative of steps of one embodiment of an algorithm that can be executed to control the operation of regenerative brakes 76 of the implement 10 based on the wheel slip of the work vehicle 12. Thus, in several embodiments, the control logic 300 may be advantageously utilized in association with a system installed on or forming part of an agricultural implement to allow for real-time control of regenerative brakes of an agricultural implement without requiring substantial computing resources and/or processing time. However, in other embodiments, the control logic 300 may be used in association with any other suitable system, application, and/or the like for controlling the operation of an agricultural implement.

As shown in FIG. 4, at (302), the control logic 300 includes receiving terrain slope sensor data indicative of a slope of terrain over which a work vehicle traverses. Specifically, as mentioned above, in several embodiments, the computing system 210 is communicatively coupled to the terrain slope sensor(s) 68 via the communicative link 202. In this respect, as the implement/vehicle 10/12 travels across the field to perform an agricultural operation thereon, the computing system 210 may receive data from the terrain slope sensor(s) 68 indicative of the slope of terrain over which the work vehicle 12 is traversing.

Additionally, at (304), the control logic 300 includes determining when the work vehicle is traversing an incline based on the received terrain slope sensor data. Specifically, in several embodiments, the computing system 210 is configured to determine the when the work vehicle 12 is traversing an inline/ascending a hill based on the terrain slope sensor data received at (302). For example, in one embodiment, the computing system 210 may access a look-up table(s) stored within its memory device(s) 214 that correlates the terrain slope sensor data received at (302) to terrain slope value(s).

Furthermore, at (306), the control logic 300 includes receiving wheel slip sensor data indicative of wheel slip of a vehicle wheel of the work vehicle relative to the ground when determined that the work vehicle is traversing the incline. Specifically, as mentioned above, in several embodiments, the computing system 210 is communicatively coupled to the wheel slip sensor(s) 62 of the work vehicle 12 via the communicative link 202. In this respect, as the work vehicle 12 traverses the incline/ascends the hill, the computing system 210 may receive data from the wheel slip sensor(s) 62 indicative of the wheel slip of the vehicle wheel(s)/track assembly(ies), 16, 18 of the work vehicle 12 relative to the ground.

Moreover, at (308), the control logic 300 includes determining the wheel slip of the vehicle wheel based on the received wheel slip sensor data when determined that the work vehicle is traversing an incline. Specifically, in several embodiments, the computing system 210 is configured to determine the wheel slip of the vehicle wheel(s)/track assembly(ies) 16, 18 based on wheel slip sensor data received at (306). For example, in one embodiment, the computing system 210 may access a look-up table(s) stored within its memory device(s) 214 that correlates the wheel slip sensor data received at (306) to wheel slip value(s).

Additionally, as shown in FIG. 4, at (310), the control logic 300 includes receiving engine sensor data indicative of a rotational speed of an engine of the work vehicle when determined that the work vehicle is traversing an incline. Specifically, as mentioned above, in several embodiments, the computing system 210 is communicatively coupled to the engine sensor(s) 64 of the work vehicle 12 via the communicative link 202. In this respect, as the work vehicle 12 traverses the incline/ascends the hill, the computing system 210 may receive data from the engine sensor(s) 64 indicative of the rotational speed of the engine 24 of the work vehicle 12.

Furthermore, at (312), the control logic 300 includes determining the rotational speed of the engine of the work vehicle based on the received engine sensor data when determined that the work vehicle is traversing an incline. Specifically, in several embodiments, the computing system 210 is configured to determine the rotational speed of the engine 24 of the work vehicle 12 based on engine sensor data received at (310). For example, in one embodiment, the computing system 210 may access a look-up table(s) stored within its memory device(s) 214 that correlates the engine sensor data received at (310) to engine rotational speed value(s).

Moreover, at (314), the control logic 300 includes receiving wheel speed sensor data indicative of a rotational speed of an implement wheel of an implement being towed by the work vehicle. Specifically, as mentioned above, in several embodiments, the computing system 210 is communicatively coupled to the wheel speed sensor(s) 66 of the implement 10 via the communicative link 202. In this respect, as the work vehicle 12 traverses the incline/ascends the hill, the computing system 210 may receive data from the wheel speed sensor(s) 66 indicative of the rotational speed of the implement wheels 34, 35 of the implement 10.

Additionally, at (316), the control logic 300 includes determining the rotational speed of the implement wheel based on the received wheel speed sensor data when determined that the work vehicle is traversing an incline. Specifically, in several embodiments, the computing system 210 is configured to determine the rotational speed of the implement wheels 34, 35 of the implement 10 based on wheel speed sensor data received at (314). For example, in one embodiment, the computing system 210 may access a look-up table(s) stored within its memory device(s) 214 that correlates the wheel speed sensor data received at (314) to implement wheel speed value(s).

Furthermore, as shown in FIG. 4, at (318), the control logic 300 includes determining when the work vehicle is traversing a decline based on the received terrain slope sensor data. Specifically, in several embodiments, the computing system 210 is configured to determine the when the work vehicle 12 is traversing a decline/descending a hill based on the terrain slope sensor data received at (302). For example, in one embodiment, the computing system 210 may access a look-up table(s) stored within its memory device(s) 214 that correlates the terrain slope sensor data received at (302) to terrain slope value(s).

Determining when the work vehicle 12 is traversing the decline allows the operation of the regenerative brake(s) 76 of the implement 10 to be controlled to optimize the amount of energy produced/generated (e.g., by increasing/decreasing braking time) and stored in the energy storage device(s) 74 (e.g., battery(ies)) based on the quantity of energy consumed on the previous incline traversed by the work vehicle 12/implement 10. Such quantity of energy consumed is indicated by the wheel slip of wheels 16, 18 of the work vehicle 12, rotational speed of the engine 24 of the work vehicle 12, wheel speed of the implement wheels 34, 35, and/or the like. In this respect, the amount of energy produced and stored on the decline is optimized according to the power consumed on the previous incline.

Moreover, at (320), the control logic 300 includes controlling the operation of a regenerative brake of a regenerative braking assembly of the implement to rotationally drive an electric motor of the regenerative braking assembly when it is determined that the work vehicle is traversing the decline based on at least one of the determined wheel slip of the vehicle wheel of the work vehicle, the rotational speed of the engine of the work vehicle, or the wheel speed of the implement wheel of the implement determined when the work vehicle was traversing the incline. Specifically, as mentioned above, in several embodiments, the computing system 210 is communicatively coupled to the regenerative brake(s) 76. In this respect, when determined that the work vehicle 12 is traversing the decline/descending the hill, the computing system 210 is configured to control the operation of the regenerative brake(s) 76 to rotationally drive the electric motor(s) 72 based on at least one of the wheel slip determined at (308), the rotational speed of the engine 24 determined at (312), or the rotational speed of the implement wheels 34, 35 determined at (316).

For example, in several embodiments, the computing system 210 may be configured to control the operation of the regenerative brake(s) 76 to increase engagement of the regenerative brake(s) 76 with the electric motor(s) 72 with increases in the determined wheel slip, the determined rotational speed of the engine 24, and/or the determined rotational speed of the implement wheels 34, 35. In this respect, the quantity of electric power supplied by the electric motor(s) 72 to the energy storage device(s) 74 is increased. Thereafter, the control logic 300 returns to (302).

Additionally, the computing system 210 may be configured to control the operation of the regenerative brake(s) 76 to decrease engagement of the regenerative brake(s) 76 with the electric motor(s) 72 with decreases in the determined wheel slip, the determined rotational speed of the engine 24, and/or the determined rotational speed of the implement wheels 34, 35. In this respect, the quantity of electric power supplied by the electric motor(s) 72 to the energy storage device(s) 74 is decreased.

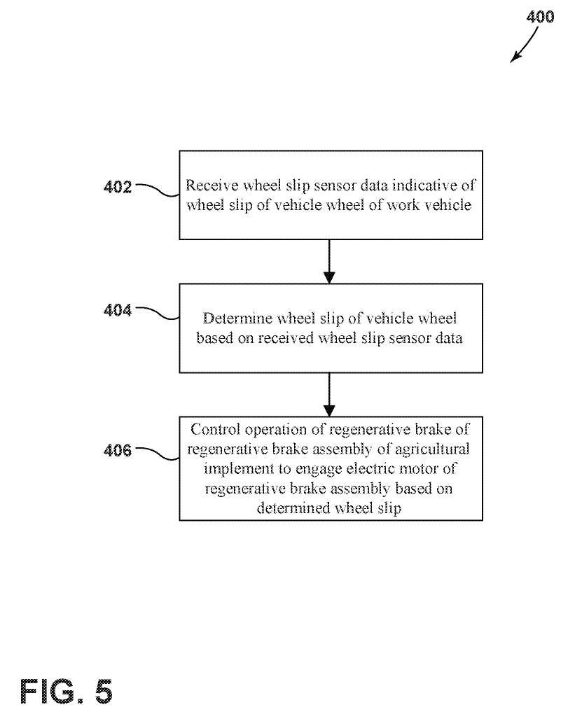

Referring now to FIG. 5, a flow diagram of one embodiment of a method 400 for controlling the operation of an agricultural implement is illustrated in accordance with aspects of the present subject matter. In general, the method 400 will be described herein with reference to the agricultural implement 10, the work vehicle 12, and the system 200 described above with reference to FIGS. 1-4. However, it should be appreciated by those of ordinary skill in the art that the disclosed method 400 may generally be implemented with any agricultural implements having any suitable implement configuration, work vehicles having any suitable vehicle configuration, and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (402), the method 400 includes receiving, with a computing system, wheel slip sensor data indicative of a wheel slip of a vehicle wheel of a work vehicle. For instance, as described above, the computing system 210 may be configured to receive data from the wheel slip sensor 62 indicative of the wheel slip of the vehicle wheel(s)/track assembly(ies) 16, 18 of the work vehicle 12.

Additionally, at (404), the method 400 includes determining, with the computing system, the wheel slip of the vehicle wheel based on the received wheel slip sensor data. For instance, as described above, the computing system 210 may be configured to determine the wheel slip of the vehicle wheel(s)/track assembly(ies) 16, 18 based on the received wheel slip sensor data.

Moreover, at (406), the method 400 includes controlling, with the computing system, an operation of a regenerative brake of a regenerative brake assembly of an agricultural implement to engage an electric motor of the regenerative brake assembly based on the determined wheel slip. For instance, as described above, the computing system 210 may be configured to control the operation of the regenerative brake(s) 76 of the regenerative brake assembly 70 of the implement 10 to engage the electric motor(s) 72 of the regenerative brake assembly 70 based on the determined wheel slip.

It is to be understood that the steps of the control logic 300 and the method 400 are performed by the computing system 210 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 210 described herein, such as the control logic 300 and the method 400, is implemented in software code or instructions which are tangibly stored on a tangible computer readable medium. The computing system 210 loads the software code or instructions via a direct interface with the computer readable medium or via a wired and/or wireless network. Upon loading and executing such software code or instructions by the computing system 210, the computing system 210 may perform any of the functionality of the computing system 210 described herein, including any steps of the control logic 300 and the method 400 described herein.

The term "software code" or "code" used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term "software code" or "code" also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural machine, comprising:
a work vehicle comprising a vehicle wheel configured to move the work vehicle in a direction of travel; a wheel slip sensor configured to generate data indicative of wheel slip of the vehicle wheel relative to the ground; an agricultural implement configured to be towed by the work vehicle, the agricultural implement comprising: an implement wheel configured to move the agricultural implement in the direction of travel; and a regenerative brake assembly comprising: an energy storage device; an electric motor electrically coupled to the energy storage device; and a regenerative brake configured to rotationally drive the electric motor; and a computing system communicatively coupled to the wheel slip sensor and the regenerative brake, the computing system configured to: determine the wheel slip of the vehicle wheel based on the data generated by the wheel slip sensor; and control an operation of the regenerative brake to rotationally drive the electric motor based on the determined wheel slip.

2. The agricultural machine of claim 1, the work vehicle further comprising:an engine configured to provide power to the vehicle wheel to move the work vehicle in the direction of travel; and an engine sensor configured to generate data indicative of a rotational speed of the engine, and wherein, the computing system is communicatively coupled to the engine sensor, the computing system further configured to:determine the rotational speed of the engine based on the data generated by the engine sensor; and control the operation of the regenerative brake to rotationally drive the electric motor based on the determined rotational speed of the engine.

3. A system for controlling the operation of an agricultural implement, the system comprising:
a vehicle wheel of a work vehicle configured to move the work vehicle in a direction of travel;
a wheel slip sensor configured to generate data indicative of wheel slip of the vehicle wheel relative to the ground;
an implement wheel of an agricultural implement configured to be towed by the work vehicle, the implement wheel configured to move the agricultural implement in the direction of travel;
a regenerative brake assembly of the agricultural implement comprising:
an energy storage device;
an electric motor electrically coupled to the energy storage device, the electric motor configured to receive electrical power from the energy storage device for rotating the implement wheel, and supply power to the energy storage device; and
a regenerative brake configured to rotationally drive the electric motor such that electric power is supplied by the electric motor to the energy storage device when the regenerative brake engages the electric motor; and
a computing system communicatively coupled to the wheel slip sensor and the regenerative brake, the computing system configured to:
determine the wheel slip of the vehicle wheel based on the data generated by the wheel slip sensor; and
control an operation of the regenerative brake to rotationally drive the electric motor based on the determined wheel slip.

4. The system of claim 3, wherein:
increases in engagement of the regenerative brake with the electric motor result in increases in the electric power supplied by the electric motor to the energy storage device; and
decreases in engagement of the regenerative brake with the electric motor result in decreases in the electric power supplied by the electric motor to the energy storage device.

5. The system of claim 4, wherein, when controlling the operation of the regenerative brake to rotationally drive the electric motor, the computing system is configured to:
control the operation of the regenerative brake to increase engagement of the regenerative brake with the electric motor with increases in the determined wheel slip of the vehicle wheel; and
control the operation of the regenerative brake to decrease engagement of the regenerative brake with the electric motor with decreases in the determined wheel slip of the vehicle wheel.

6. The system of claim 4, further comprising:
a work vehicle engine configured to provide power to the vehicle wheel to move the work vehicle in the direction of travel; and
an engine sensor configured to generate data indicative of a rotational speed of the engine, and
wherein, the computing system is communicatively coupled to the engine sensor, the computing system further configured to:
determine the rotational speed of the work vehicle engine based on the data generated by the engine sensor; and
control the operation of the regenerative brake to rotationally drive the electric motor based on the determined rotational speed of the work vehicle engine.

7. The system of claim 6, wherein, when controlling the operation of the regenerative brake to rotationally drive the electric motor, the computing system is configured to:
control the operation of the regenerative brake to increase engagement of the regenerative brake with the electric motor with increases in the determined rotational speed of the work vehicle engine; and
control the operation of the regenerative brake to decrease engagement of the regenerative brake with the electric motor with decreases in the determined rotational speed of the work vehicle engine.

8. The system of claim 3, further comprising:
a terrain slope sensor configured to generate data indicative of a slope of terrain over which the work vehicle traverses, and
wherein, the computing system is communicatively coupled to the terrain slop sensor, the computing system further configured to:
determine when the work vehicle is traversing an incline based on the data generated by the terrain slope sensor; and
determine the wheel slip of the vehicle wheel based on the data generated by the wheel slip sensor when it is determined that the work vehicle is traversing the incline.

9. The system of claim 8, wherein, after determining that the work vehicle is traversing an incline, the computing system is further configured to:
determine when the work vehicle is traversing a decline based on the data generated by the terrain slope sensor; and
control the operation of the regenerative brake to rotationally drive the electric motor when it is determined that the work vehicle is traversing the decline based on the wheel slip of the vehicle wheel determined when the work vehicle was traversing the incline.

10. The system of claim 8, wherein the terrain slope sensor is configured as an inclinometer.

11. The system of claim 3, further comprising:
a wheel speed sensor configured to generate data indicative of a rotational speed of the implement wheel, and
wherein, the computing system is communicatively coupled to the wheel speed sensor, the computing system further configured to:
determine the rotational speed of the implement wheel based on the data generated by the wheel speed sensor; and
control the operation of the regenerative brake to increase engagement of the regenerative brake with the electric motor with increases in the determined rotational speed of the implement wheel.

12. The system of claim 11, wherein the computing system is further configured to:
control the operation of the regenerative brake to decrease engagement of the regenerative brake with the electric motor with decreases in the determined rotational speed of the implement wheel.

13. A method for controlling the operation of an agricultural implement, the method comprising:
receiving, with a computing system, wheel slip sensor data indicative of a wheel slip of a vehicle wheel of a work vehicle;
determining, with the computing system, the wheel slip of the vehicle wheel based on the received wheel slip sensor data; and
controlling, with the computing system, an operation of a regenerative brake of a regenerative brake assembly of an agricultural implement to engage an electric motor of the regenerative brake assembly based on the determined wheel slip.

14. The method of claim 13, further comprising:
when controlling the operation of the regenerative brake to rotationally drive the electric motor, controlling, with the computing system, the operation of the regenerative brake to increase engagement of the regenerative brake with the electric motor with increases in the determined wheel slip of the vehicle wheel; and
when controlling the operation of the regenerative brake to rotationally drive the electric motor, controlling, with the computing system, the operation of the regenerative brake to decrease engagement of the regenerative brake with the electric motor with decreases in the determined wheel slip of the vehicle wheel.

15. The method of claim 13, further comprising:
receiving, with the computing system, engine sensor data indicative of a rotational speed of the engine;
determining, with the computing system, the rotational speed of a work vehicle engine based on the received engine sensor data; and
controlling, with the computing system, the operation of the regenerative brake to rotationally drive the electric motor based on the determined rotational speed of the work vehicle engine.

16. The method of claim 15, further comprising:
when controlling the operation of the regenerative brake to rotationally drive the electric motor, controlling, with the computing system, the operation of the regenerative brake to increase engagement of the regenerative brake with the electric motor with increases in the determined rotational speed of the work vehicle engine; and
when controlling the operation of the regenerative brake to rotationally drive the electric motor, controlling, with the computing system, the operation of the regenerative brake to decrease engagement of the regenerative brake with the electric motor with decreases in the determined rotational speed of the work vehicle engine.

17. The method of claim 13, further comprising:
receiving, with the computing system, terrain slope sensor data indicative of a slope of terrain over which the work vehicle traverses;
determining, with the computing system, when the work vehicle is traversing an incline based on the received terrain slope sensor data; and
determining, with the computing system, the wheel slip of the vehicle wheel based on the received wheel slip sensor data when it is determined that the work vehicle is traversing the incline.

18. The method of claim 17, further comprising:
after determining that the work vehicle is traversing an incline, determining, with the computing system, when the work vehicle is traversing a decline based on the data generated by the terrain slope sensor; and
controlling, with the computing system, the operation of the regenerative brake to rotationally drive the electric motor when it is determined that the work vehicle is traversing the decline based on the wheel slip of the vehicle wheel determined when the work vehicle was traversing the incline.

19. The method of claim 13, further comprising:
receiving, with the computing system, wheel speed sensor data indicative of a rotational speed of an implement wheel;
determining, with the computing system, the rotational speed of the implement wheel based on the received wheel speed sensor data; and
controlling, with the computing system, the operation of the regenerative brake to increase engagement of the regenerative brake with the electric motor with increases in the determined rotational speed of the implement wheel.

20. The method of claim 13, further comprising:
controlling, with the computing system, the operation of the regenerative brake to decrease engagement of the regenerative brake with the electric motor with decreases in the determined rotational speed of the implement wheel.
